(19) United States
(12) Patent Application Publication
(10) Pub. No.: US 2002/0129758 A1
(43) Pub. Date: Sep. 19, 2002

(54) Medication dose reminder

(76) Inventors: Jill A. Hanley, Wheaton, IL (US); Terri Ketcham, Bloomingdale, IL (US)

Correspondence Address: LATHROP & CLARK LLP, 740 REGENT STREET SUITE 400, P.O. BOX 1507, MADISON, WI, 537011507

(21) Appl. No.: 09/971,441

(22) Filed: Oct. 5, 2001

Related U.S. Application Data
(60) Provisional application No. 60/238,596, filed on Oct. 6, 2000.

(51) Int. Cl. G09F 9/00

(52) U.S. Cl. 116/308

(57) ABSTRACT

A medication dose reminder that is readily visible at a distance that is safe and easy to use.

This application is a continuation of Provisional Application No. 60/238,596 filed Oct. 6, 2000, the disclosure of which is incorporated by reference herein.

### FIELD AND BACKGROUND OF THE INVENTION

This invention related generally to medication dose reminders and particularly to a medication does reminder that is easily displayed and viewed without the dangers of child tampering or medication storage.

A number of medication dose reminders are known which are stored in locations such as drawers, refrigerators, or medicine cabinets. This type of medication dose reminder typically has reminder markings that are printed or embossed on the device.

Some medication dose reminders store medicine. Such designs have a number of compartments that store medicine and indicate in some fashion when the medicine should be taken. If a compartment is empty, it is assumed that the medicine was taken.

Specific prior art devices include a plastic pill keeper that contains a multi-day supply of pills marked for each day of the week. A similar design labeled morning, noon and night is also available.

Another prior art device is a digital, programmable timer that contains compartments for medication.

Because these products contain the actual medication, they cannot be left out on counters or in the open around children; and consequently, remembering to take them can be challenging. In addition, the digital pillbox is very difficult to use and program. Neither of these prior art devices can be used with liquid medication. In addition, neither of these products is as visually appealing as the present invention.

There is a need for a medication dose reminder that provides reliable reminder messages, is readily visible at a distance, and is safe for use around children.

### SUMMARY OF THE INVENTION

The present invention will be used to help remind individuals who are on medication when to take medication and of the number of doses they have already taken on any particular day of the week. The present invention can have a pull-out easel on the back for placement on flat, horizontal surfaces as well as magnets to attach it to the refrigerator or any other metal surface. In some embodiments, the invention will include:

Sized to about 3″×1¾″ for portability.

Manufactured in plastic or other lightweight, inexpensive material.

Two windows indicating number of doses taken and the day of week.

Push button or dial mechanism (similar to a baseball scorekeeper) to advance days & numbers (forward direction only to avoid accidentally turning the dial backward) in the windows.

Multiple dose ranges and days for display.

Transparent red octagonal stop sign window that slides over the displayed day to indicate further medication is unnecessary.

Large lettering and numbering. Renewable, write-on strips at the top, for example, to indicate the name of person taking the medication. (Avery adhesive, Colorform, or Cling type labels can be used.)

Renewable, write-on strips at the bottom, for example, to indicate name of medication and any other necessary information, such as the number of doses per day and the dosage amount.

Small pocket at the back to store renewable strips.

Extra space on the labels to provide to placement of a store label or other prescription indicator.

Cheerful, colorful character designs can be used to enhance interest.

Push button or dial mechanisms to record a dosage taken, and that is preferably tamper resistant to avoid untimely changes.

### BRIEF DESCRIPTION OF THE DRAWINGS

FIG. 1 is a front view of a medication dosage reminder in accordance with the present invention;

FIG. 2 is a back view of the medication dosage reminder of FIG. 1;

FIG. 3 is a top of the medication dosage reminder of FIG. 1;

FIG. 4 is a top view of an alternate embodiment of a medication dosage reminder in accordance with the present invention;

FIG. 5 is a side view of a medication dosage reminder with a dial type changer in accordance with the present invention; and

FIG. 6 is a side view of a medication dosage reminder with a button-type changer in accordance with the present invention.

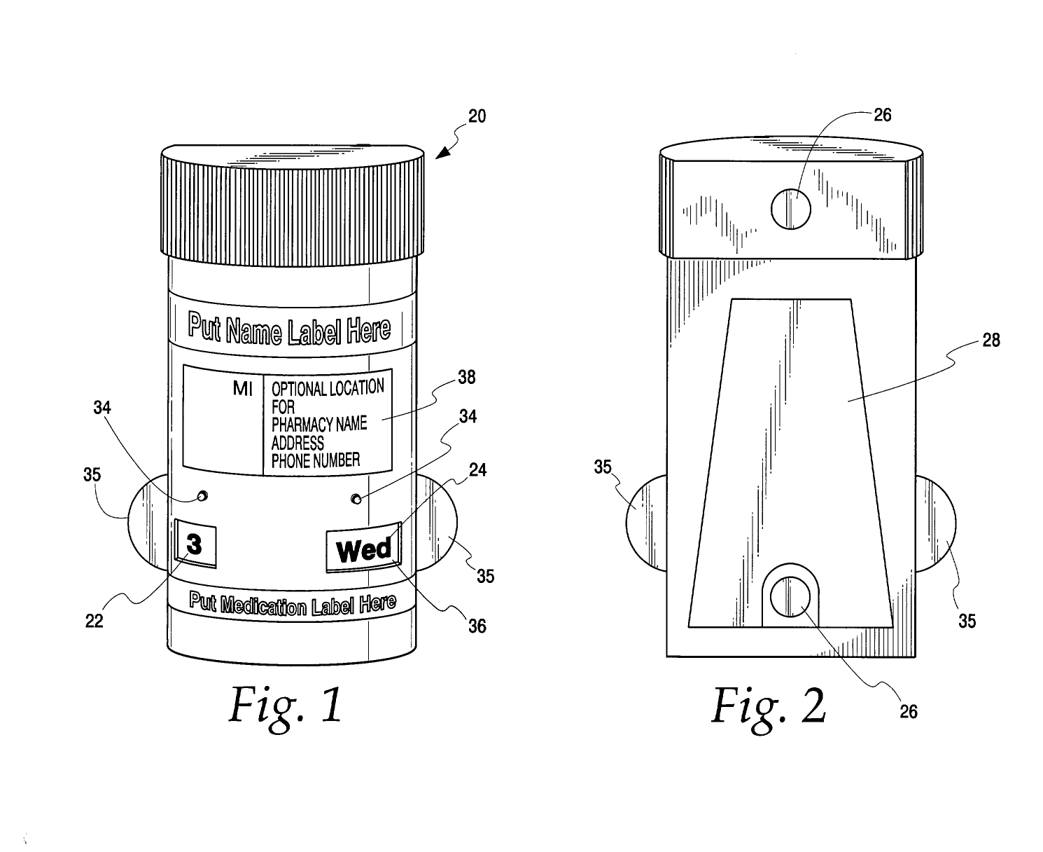

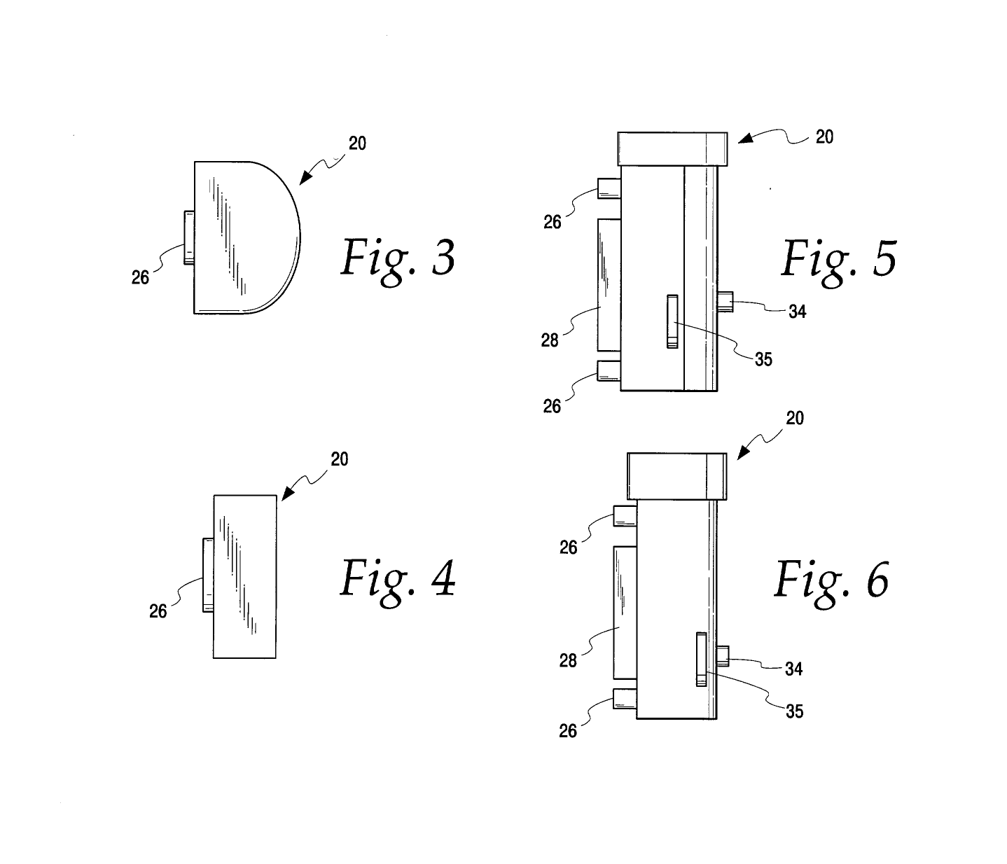

### DETAILED DESCRIPTION OF THE DRAWINGS

The present invention is a useful and novel easy-to-use pushbutton or dial medication dose reminder. Its primary use is as a reminder of how many doses of medication have been taken in any given day although there are many other uses. It can also be designed with locks, resilient tabs, or tamper-resistant devices to provide a child safe product for reminding its user of any redundant task.

One preferred shape of the dose reminder is of a medicine bottle shape-easily recognizable and relevant to its use. Large, easy to recognize numbers and letters are coupled with a red stop sign window to indicate the end of the day's dosage.

It is a product that has consumer appeal to a variety of target groups.

Busy Parents:

Parents have a responsibility to keep medications out of the reach of children. At the same time, they are responsible for administering medication to their children. Some popular medications need to be refrigerated and, again, out of the line of sight. The present invention has a magnet on back so that it can be conveniently located on the refrigerator door or other metallic surface. When a supervising adult sees the reminder, the medication is only an arm's length away. Children will enjoy taking their medications, just to see the days and numbers change. If children tamper with the present invention when an adult is not watching, there is no dangerous medication in the device that could harm the child.

The present invention also has a pull out easel back for placement on a countertop in the kitchen, bathroom or bedroom. It can be used in the administration of medication, as well as tracking diaper changes, breast feedings, etc.

The present invention is lightweight and portable so it can be easily packed in a suitcase, diaperbag, or purse.

The adhering labels and any ballpoint pen make it ideal when there are multiple children in a family or multiple medications. Each child can have his/her own dose reminder device. Family pet needs can also be recorded using the present invention.

The Elderly:

The elderly can sometimes be forgetful. The present invention can help them remember how many doses of medication they have taken on a particular day. The mechanics are simple to understand and the buttons are easy to use. It has large easy-to-read numbers and letters. The colorful “Stop” window can be seen from a distance, and save them the effort of locating and reading other types of dose reminders.

Some medications and vitamins need to be taken with food. The present invention is mountable on the refrigerator door or kitchen countertop so it is within easy reach of food and prescription or vitamin.

The low cost and convenient identification labels mean they can have a dose reminder for each medication they take and keep track of these multiple medications without confusion.

Finally, pharmacies can use this low-cost invention as a promotional item. The prescription label can be imprinted with the pharmacy name, address, phone number, and hours of operation. When a patient needs to give this information to a physician over the phone or refer to it themselves, it will be ready and accessible from the refrigerator or countertop.

The following charts A through C provide example scenarios of using the present invention.

[image]

[image]

[image]

The foregoing description of the drawings is provided for clearness of understanding only. One of ordinary skill in the art will recognize obvious modifications that are within the scope of the present invention.

1. A medication dose reminder comprising:
a housing;
a dose indicator mounted in the housing;
a date indicator mounted in the housing;
a dose indicator activator that causes the dose indicator to reflect that a medication dose has been taken; and
a date indicator activator that causes the date indicator to reflect a date corresponding to the dose indicator.

2. The medication dose reminder of claim 1, wherein the dose indicator activator is a push button mechanism.

3. The medication dose reminder of claim 1, wherein the dose indicator activator is a manual dial mechanism.

4. The medication dose reminder of claim 1, wherein the dose indicator includes an in dication to stop taking further doses of medication.
